(19) United States
(12) Patent Application Publication
(10) Pub. No.: US 2012/0233575 A1
(43) Pub. Date: Sep. 13, 2012

(54) LAYOUT METHOD FOR INTEGRATED CIRCUIT INCLUDING VIAS

(75) Inventor: Madhur KASHYAP, Noida (IN)

(73) Assignee: FREESCALE SEMICONDUCTOR, INC., Austin, TX (US)

(21) Appl. No.: 13/044,578

(22) Filed: Mar. 10, 2011

(51) Int. Cl. G06F 17/50

(52) U.S. Cl. 716/55

(57) ABSTRACT

A layout method for an integrated circuit including vias connecting stacked metal layers through cuts in intermediate cut layers includes generating interconnection blockage and obstruction statements that define exclusion regions of the metal layers blocked by existing initial interconnections for routing additional interconnections. Shape, size and spacing data are generated for de-selection areas of the exclusion regions in the conductive layers. The de-selection areas are sufficiently far from the boundaries of the exclusion regions that cut spacing rules applied to the initial cuts within the de-selection areas do not block placement of additional cuts outside the exclusion regions of the conductive layers. Only those of the initial cuts within the exclusion regions that lie outside the de-selection areas are selected. Cut blockage and obstruction statements are generated for the selected cuts. A layout view is derived, including routing the additional interconnections in the electrically conductive layers and placing the additional cuts.

### BACKGROUND OF THE INVENTION

The present invention is directed integrated circuits and, more particularly, to a method of layout of a semiconductor integrated circuit including vias.

A semiconductor integrated circuit (IC) includes complex interconnected semiconductor circuit modules each having many interconnected elements. An IC chip has a semiconductor substrate, a face of which typically bears a stack of several electrically conductive layers, usually of metal, each of which is patterned with shapes to form interconnections within the layer. The different conductive layers are separated by intermediate layers of electrically insulating material and also are connected to each other and to the semiconductor substrate vertically of the stack by Vertical Interconnect Access connections, known as ‘vias’ of electrically conductive material that pass through apertures or ‘cuts’ in the intermediate insulating layers.

Integrated circuit layout, also known as IC layout, IC mask layout, or mask design, is the representation of an IC in terms of planar geometric shapes that correspond to the patterns of metal, oxide, or semiconductor layers that make up the components of the IC. An IC may have millions of electrical components, such as transistors, capacitors, inductors and their interconnections, particularly in the case of system-on-chip ICs (SOC).

IC layout is performed with the aid of IC layout editor software, semi-automatically or even automatically using electronic design automation (EDA) tools, including place and route tools or schematic driven layout tools. The layout process is often facilitated by using manufacturing-technology-dependent libraries of standard cells, memories, analog and other hard macros developed at the transistor level in the form of transistor netlists. The netlist is a nodal description of transistors, their connections to each other, and their ports to the external environment. A synthesis tool may be used to transform the IC's register-transfer level (RTL) description into a technology-dependent netlist of standard cells, any design-specific cells and the interconnections of the ports of the cells.

Semi-automatic or automatic placing and routing tools may then be used to assign locations for each cell in the cell netlist and signal connection lines or ‘wires’ and power supply lines or ‘wires’. In addition, placing and routing tools must take into account a number of manufacturing and performance criteria, including, in the case of interconnections, minimum conductor width, conductor-to-conductor spacing, and spacing between via cuts in the intermediate insulating layers. The addition of the data for these criteria to the data for size and positioning of cells and their ports, and shape, size and relative positioning of interconnections between the cells and input/output (‘I/O’) ports of the IC in a given layer and between layers in the form of vias, renders the placing and routing process laborious and very computationally intensive and run times are long.

The place and route tools position only metal interconnections between cells, memories, and other circuit elements. Hence they only require as input data the shapes and locations of ports and of regions that are occupied within the cell and represent obstructions in each interconnection layer. In other words, the ports and regions are exclusion areas of the layer that are not available for the automated place and route tool to use for routing the interconnections. Such simplified input data corresponds to a view of the cells known as an Abstract View or Abstract Model of the detailed layout.

The resulting detailed cell layout views from the automated place and route tool undergo design rule checking (DRC) to achieve a high overall yield and reliability for the design. DRC is a very computationally intense task. If the cell abstract views are not accurate, they cause violations of design rules and the layout process must then be reiterated with changes to correct the violations, which aggravates the computational load of the layout process.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a simplified flow chart of an automated IC layout process, including a step of routing interconnections, given by way of example;

FIG. 2 is a simplified flow chart of steps for generating obstructions in the step of routing conductors in the layout method of FIG. 1;

FIG. 3 is a simplified schematic layout of part of a semiconductor device whose interconnections are to be routed using the steps of FIG. 1;

FIG. 4 is a simplified abstract view showing obstructions and ports for the part of the semiconductor device shown in FIG. 3, as used in a known example of the steps shown in FIG. 2;

FIG. 5 is a schematic plan view of the part of the semiconductor device shown in FIGS. 3 and 4 showing interconnects produced using the obstructions and ports of the abstract view of FIG. 4;

FIG. 6 is a schematic plan view of the part of the semiconductor device shown in FIG. 3 showing interconnects produced using obstructions and ports of a simpler abstract view than FIG. 4 together with maximum spacing criteria in another known example of the steps shown in FIG. 2;

FIG. 7 is a schematic plan view of the part of the semiconductor device shown in FIG. 3 showing interconnects produced using obstructions and ports of the abstract view of FIG. 6 together with minimum spacing criteria in yet another known example of the steps shown in FIG. 2;

FIG. 8 is a simplified flow chart of steps for generating obstructions in the step of routing conductors in the layout method of FIG. 1 in accordance with one embodiment of the invention, given by way of example;

FIG. 9 is a simplified abstract view showing obstructions and ports for the part of the semiconductor device shown in FIG. 3, as used for generating obstructions in the example of the embodiment of the invention shown in FIG. 8; and

FIG. 10 is a schematic plan view of the part of the semiconductor device shown in FIG. 3 showing an example of interconnects produced using the obstructions and ports of the abstract view of FIG. 9.

### DETAILED DESCRIPTION OF THE INVENTION

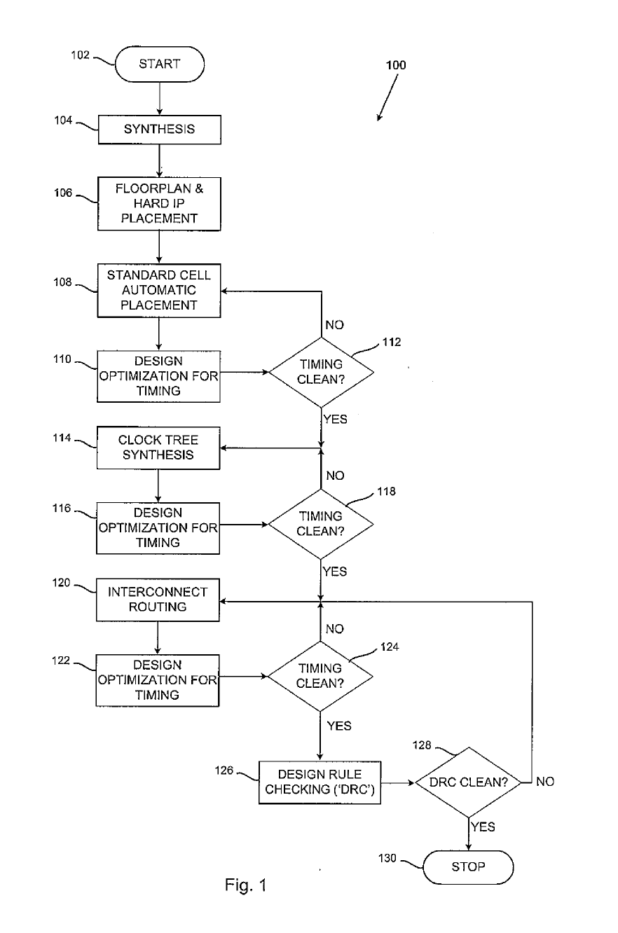

FIG. 1 illustrates a typical automated IC layout process 100, including a step of routing interconnections, given by way of example, and which may be used in the present invention, although other processes may be used. The process 100 starts at 102. At 104, a synthesis tool performs the process of transforming the ASIC's register-transfer level (‘RTL’) description into a technology-dependent netlist of standard cells and any design-specific cells. At 106, the overall IC floor plan is defined and re-used cell modules (‘hard IP’) are placed.

At 108, the standard cells are placed semi-automatically or automatically. Timing characteristics with the resulting placement are evaluated at 110. At 112, if the timing criteria do not meet the specifications, the process reverts to step 108, and the standard cell placement and/or netlist are revised to improve timing.

If the timing criteria meet the specifications at 112, the clock trees are synthesized at 114. Timing characteristics with the resulting clock trees are evaluated at 116. At 118, if the timing criteria do not meet the specifications, the process reverts to step 114, and the clock tree synthesis is revised.

If the timing criteria meet the specifications at 118, the routing tools are used semi-automatically or automatically to define the interconnections at 120. Timing characteristics with the resulting interconnections are evaluated at 122. At 124, if the timing criteria do not meet the specifications, the process reverts to step 120, and the interconnection definitions are revised.

If the timing criteria meet the specifications at 124, the resulting detailed layout is subjected to design rule checking (‘DRC’) at 126. At 128, if the DRC does not meet the specifications, the process reverts to step 120, and the interconnect routing is revised.

Various place and route tools are commercially available. Certain of these tools use Design Exchange Format (‘DEF’) and Library Exchange Format (‘LEF’) to represent in an ASCII format the netlist and circuit physical layout of respectively design-specific and standard cells in an IC while it is being designed. DEF and LEF are open specifications. Examples will be given in the following description using DEF and LEF but it will be appreciated that the present invention is not limited to the use of these specifications.

The following is an example of the type of statements used in LEF to specify CUT layer definition, which in turn will define the parameters for the vias in the finished device:

```
LAYER layerName
  TYPE CUT ;
  [SPACING cutSpacing
    [CENTERTOCENTER]
    [SAMENET]
    [ LAYER secondLayerName [STACK]
      | ADJACENTCUTS {2 | 3 | 4} WITHIN cutWithin
[EXCEPTSAMEPGNET]
      | PARALLELOVERLAP
      | AREA cutArea
    ]
  ;] ...
  [PROPERTY LEF57_SPACING
    ″SPACING cutSpacing
    [CENTERTOCENTER]
    [SAMEMETAL]
    [ LAYER secondLayerName [STACK]
      | ADJACENTCUTS {2 | 3 | 4} WITHIN cutWithin
[EXCEPTSAMEPGNET]
      | PARALLELOVERLAP
      | AREA cutArea] ;″ ;]
  [SPACINGTABLE ORTHOGONAL
    {WITHIN cutWithin SPACING orthoSpacing} ... ;]
  [ARRAYSPACING [LONGARRAY] [WIDTH viaWidth]
  CUTSPACING cutSpacing
    {ARRAYCUTS arrayCuts SPACING arraySpacing} ... ;]
  [WIDTH minWidth ;]
  [ENCLOSURE [ABOVE | BELOW] overhang1 overhang2
  [ WIDTH minWidth [EXCEPTEXTRACUT cutWithin]
    | LENGTH minLength]
  ;] ...
  [PREFERENCLOSURE [ABOVE | BELOW] overhang1 overhang2
[WIDTH minWidth];] ...
  [PROPERTY LEF57_ENCLOSURE
  ”ENCLOSURE [ABOVE | BELOW] overhang1 overhang2
  [ WIDTH minWidth
  [EXCEPTEXTRACUT cutWithin [NOSHAREDEDGE]]
  ] ;” ;]
  [PROPERTY LEF57_ENCLOSUREEDGE
    ″ENCLOSUREEDGE [ABOVE | BELOW] overhang
    WIDTH minWidth PARALLEL parLength WITHIN parWithin
  [EXCEPTEXTRACUT] ;″ ;]
  [RESISTANCE resistancePerCut ;]
  [PROPERTY propName propVal ;] ...
  [ACCURRENTDENSITY {PEAK | AVERAGE | RMS}
    { value
      | FREQUENCY freq_1 freq_2 ... ;
    [CUTAREA cutArea_1 cutArea_2 ... ;]
    TABLEENTRIES
      v_freq_1_cutArea_1 v_freq_1_cutArea_2 ...
      v_freq_2_cutArea_1 v_freq_2_cutArea_2 ...
      ...
    } ;]
  [DCCURRENTDENSITY AVERAGE
  { value
    | CUTAREA cutArea_1 cutArea_2 ... ;
    TABLEENTRIES value_1 value_2 ...
  } ;]
  [ANTENNAMODEL {OXIDE1 | OXIDE2 | OXIDE3 | OXIDE4} ;] ...
  [ANTENNAAREARATIO value ;] ...
  [ANTENNADIFFAREARATIO {value | PWL ( ( d1 r1 ) ( d2 r2 ) ...)}
;] ...
  [ANTENNACUMAREARATIO value ;] ...
  [ANTENNACUMDIFFAREARATIO {value | PWL ( ( d1 r1 ) ( d2 r2 )
...)} ;] ...
  [ANTENNAAREAFACTOR value [DIFFUSEONLY] ;] ...
  [ANTENNACUMROUTINGPLUSCUT ;]
  [ANTENNAGATEPLUSDIFF plusDiffFactor ;]
  [ANTENNAAREAMINUSDIFF minusDiffFactor ;]
  [ANTENNAAREADIFFREDUCEPWL
    ( ( diffArea1 diffAreaFactor1 ) ( diffArea2 diffAreaFactor2 )
...) ; ]
END layerName
```

‘SPACING’ specifies the minimum distance to be respected from one cut edge to the next cut edge and is applicable when two single cuts are in vicinity which do not share metal above or below. This ‘SPACING’ would be smallest of all spacing rules. ‘ADJACENTCUTS’ spacing rules specify the minimum spacing of a cut edge from a cluster of cuts not sharing metal above or below and lying at ‘SPACING’ distance from each other. ‘ARRAYSPACING’ rules specify the minimum ‘cutSpacing’ between cuts of an array and also the minimum ‘arraySpacing’ between two arrays for a given array size, where the two arrays may or may not share metal above or below. The intra layer cut spacing is to be respected within each of the routing layers, and the inter-layer spacing is to be respected between two different cut layers.

It will be appreciated that the volume of data to be processed, when multiplied by the large number of connections in an IC, renders the placing and routing process laborious and very computationally intensive and hence tool run times are long. A first known approach to reduce the volume of data is to divide the design into various hierarchies and use either a top-down or a bottom-up design approach. In a bottom-up design approach the upper hierarchies use abstract views or models defined by lower hierarchy levels of areas and ports which are unavailable for routing interconnections in the upper level. This information is known as OBSTRUCTIONS and PORTS in LEF standard terminology. In a top-down design approach the areas and ports which are unavailable for routing interconnections are communicated across hierarchies from upper levels to lower levels. These unavailable areas and ports are known as BLOCKAGES and PORTS in DEF standard terminology.

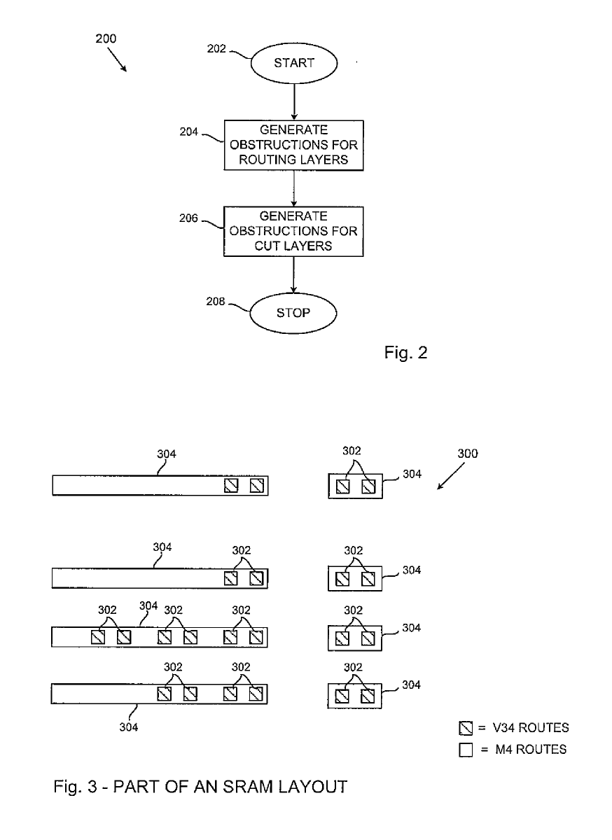

FIG. 2 illustrates a generic process 200 of generating obstructions. These steps are applicable to both top-down and bottom-up approach. The process 200 generates LEF OBSTRUCTIONS or DEF BLOCKAGES for the shapes in the routing layers and for the cut shapes in the cut layers. The process 200 starts at 202. At 204, LEF OBSTRUCTIONS or DEF BLOCKAGES are generated for the shapes in the routing layers. At 206, LEF OBSTRUCTIONS or DEF BLOCKAGES are generated for the shapes in the cut layers. The process 200 finishes at 208.

The OBSTRUCTION statement under LEF Abstract Macro takes the following form:

```
[OBS
  { LAYER layerName
  [EXCEPTPGNET]
  [SPACING minSpacing | DESIGNRULEWIDTH value] ;
  [WIDTH width ;]
  { PATH pt ... ;
    | PATH ITERATE pt ... stepPattern ;
    | RECT pt pt ;
    | RECT ITERATE pt pt stepPattern ;
    | POLYGON pt pt pt pt ... ;
    | POLYGON ITERATE pt pt pt pt ... stepPattern ;
  } ...
    | VIA pt viaName ;
    | VIA ITERATE pt viaName stepPattern ;
  } ...
END
```

An OBSTRUCTION (‘OBS’) statement defines an exclusion region in which no external interconnect should be routed. ‘DESIGNRULEWIDTH effectiveWidth’ specifies that the obstruction has a width of effectiveWidth for the purposes of spacing calculations. Alternatively, ‘SPACING minSpacing’ specifies that the minimum spacing allowed between the obstruction and any other external routing shape may be adopted.

FIG. 3 is a detailed layout view of a part of an IC 300, in this case a static random access memory module (‘SRAM’) module. The illustration is simplified to show only a few elements in an M4 metal layer and a V34 cut layer between M3 and M4 metal layers. It will be appreciated that the explanations given based on these simplified elements in two layers can be applied to complex arrays of elements in several metal and cut layers as well. Also, the process illustrated is applicable to other types of modules as well. The part shown of the SRAM module comprises a set of V34 layer cuts such as 302 which define corresponding vias in the finished device and M4 layer metal connectors such as 304.

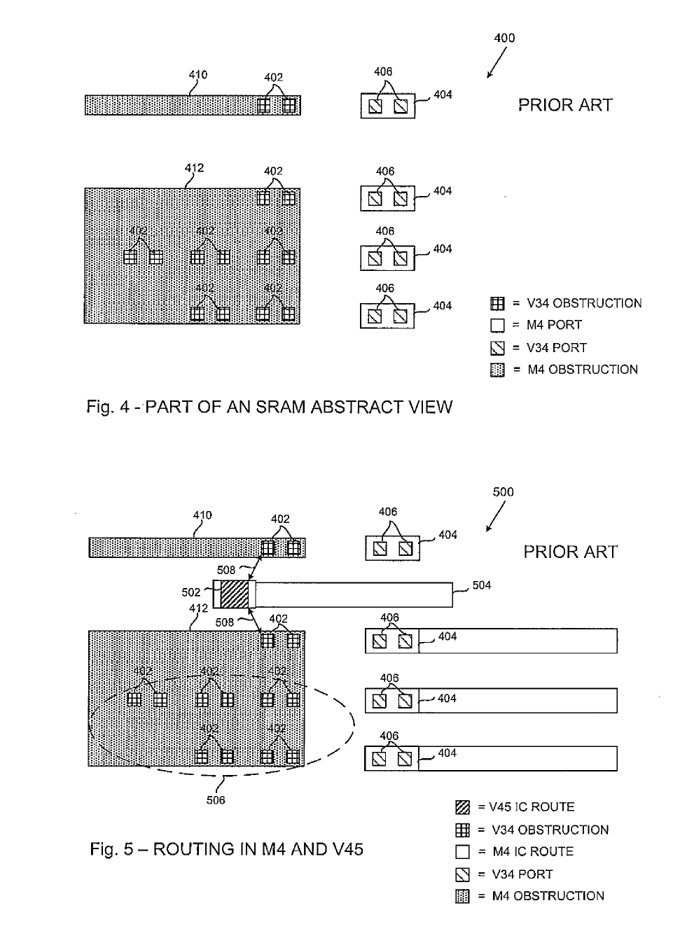

The use of intra-layer and inter-layer individual shape and array OBSTRUCTION statements for routing shapes for placing cuts reduces the volume of data to be processed when checking respect of spacing statements but this reduced volume of data to be processed for complex ICs is still often enormous, if the result is to be accurate. FIG. 4 is an Abstract view (LEF) 400 of the part of the IC 300 shown in FIG. 3 as used in a known process. The Abstract view 400 contains detailed cut obstructions such as 402 as generated by the process 200 for all of the V34 cuts 302 in order to ensure accuracy. The Abstract view 400 also contains M4 layer ports such as 404, V34 cut layer ports such as 406 and M4 metal layer obstructions 410 and 412, the obstruction 410 covering a single metal connector 304, and obstruction 412 covering a plurality of the metal connectors 304, by way of example. The process is illustrated at a stage where a standard cell has been placed, certain M4 layer metal interconnections have been routed and certain V34 layer cuts have been placed, these existing or initial elements being considered to be fixed for the purpose of routing additional M4 and M4 layer interconnections and for placing additional V34 and V45 layer cuts.

FIG. 5 shows the M4 and V45 level interconnect routes 500 resulting from the automated routing tool using the Abstract view of FIG. 4 for the IC 300, the M5 and other level interconnects being omitted for simplicity. The interconnect routes 500 include a V45 layer cut 502 and an M4 layer metal connection 504, in addition to the elements of the Abstract view 400 (a corresponding M5 layer metal connection with the V45 layer cut 502 does not appear in FIG. 5). The resulting M4 and V45 interconnect routes 500 ensure that the V45 cut 502 is sufficiently away from all the V34 cut obstructions 402 to avoid cut spacing design rule violations, as indicated by the arrows 508. However, the process takes account of data even for those of the V34 cut obstructions 402 within the area of the dashed oval 506 which are redundant data, since they are remote from the position of the cut 502, and even if no account were taken of their data, it would not cause any violations as no V45 cut is close to them anyway.

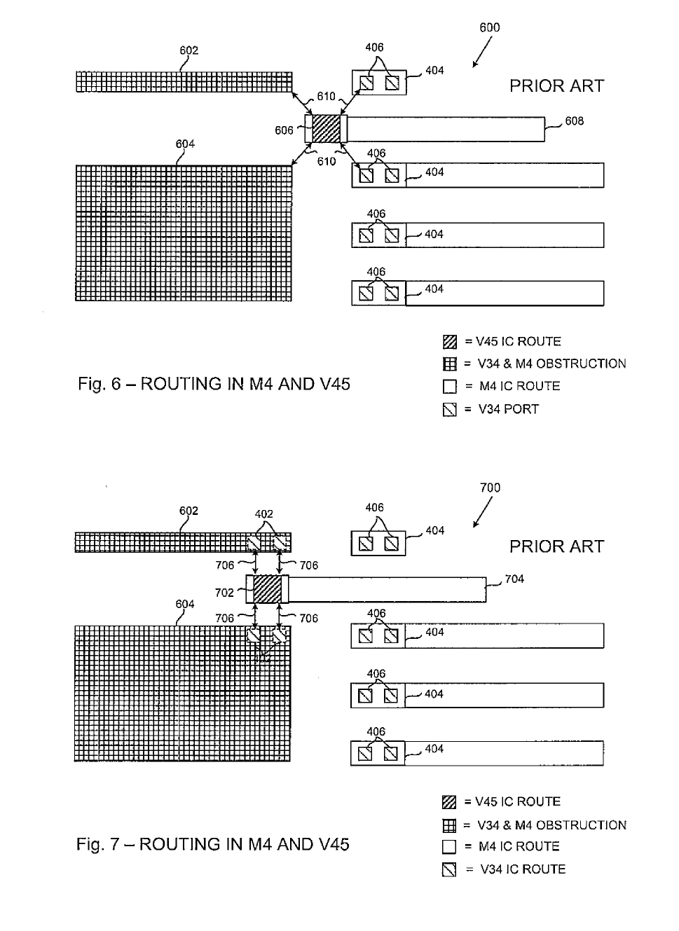

On the other hand, it is undesirable to reduce the volume of data by blindly simplifying the obstructions as this can result either in under utilization of routing resources or in compromise in accuracy. FIG. 6 is a view similar to the view of FIG. 5 showing an example of M4 and V45 interconnect routes 600 resulting from the automated routing tool using an Abstract view simplified compared to the Abstract view 400 of FIG. 4 for the IC 300. In the example of FIG. 6, the V34 cut obstructions 402 of the Abstract view 400 are simplified to blanket obstructions 602 and 604 covering the whole areas of the M4 metal layer obstructions 410 and 412, respectively, reducing the amount of data to be processed. FIG. 6 shows a result when a V45 layer cut 606 and an M4 layer metal connection 608 are routed by the automatic routing tool using the criterion ‘SPACING maxSpacing’ for the cut obstruction, corresponding to the biggest value of the different intra-layer and inter-layer individual shape and array cut spacing requirements. In this pessimistic case, the V45 layer cut 606 cannot be placed in the channel between the obstructions 602 and 604 and the ports 408 as indicated by the arrows 610, so that routing resources are wasted.

FIG. 7 is a view similar to the view of FIG. 5 showing an example of M4 and V45 interconnect routes 700 resulting from the automated routing tool using the same Abstract view as FIG. 6, simplified compared to the Abstract view 400 of FIG. 4 for the IC 300. In the example of FIG. 7, the V34 cut obstructions 402 of the Abstract view 400 are again simplified to blanket obstructions 602 and 604 covering the whole areas of the M4 metal layer obstructions 410 and 412, respectively, reducing the amount of data to be processed. FIG. 7 shows a result when a V45 layer cut 702 and an M4 layer metal connection 704 are routed by the automatic routing tool using the criterion ‘SPACING minSpacing’ for the V45 cut obstruction, corresponding to the smallest value of the different intra-layer and inter-layer individual shape and array spacing requirements for the cuts, typically a metal spacing criterion. In this optimistic case, the V45 layer cut 702 may be placed too close to the V34 layer cuts 402 in the layout causing cut spacing design rule violations, such as an inter-layer cut spacing requirement which is greater than an intra-layer metal spacing requirement for example, as indicated by the arrows 706 which are seen at the last step in flowchart of FIG. 1. The design rule violations will only be picked up at the DRC stage 126, resulting in excessive iterations of the processing.

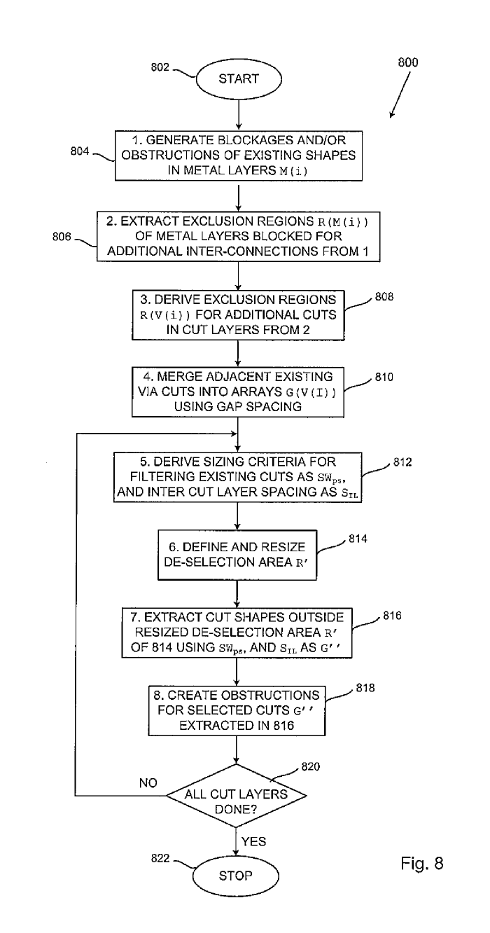

FIG. 8 is a flow chart of a method 800 of generating LEF OBSTRUCTIONS or DEF BLOCKAGES in a method of layout and production of a semiconductor IC in accordance with an example of an embodiment of the present invention. This example of an embodiment of the present invention also includes a non-transitory computer readable medium with a computer program element thereon which is executable by a data processor to perform the method 800. Layout of other elements of the IC, such as the semiconductor modules and components, may be performed using known techniques, for example. The method 800 is applicable to an IC such as an IC including the part 300 illustrated in FIG. 3 but is also applicable to other ICs. The method 800 can avoid the inaccuracies of routing the cuts 606 and 702 illustrated in FIGS. 6 and 7, while enabling a reduction in the volume of data to be processed compared to the method illustrated in FIGS. 4 and 5.

The method 800 is applicable to layout of a semiconductor integrated circuit 300 including vias connecting a plurality of stacked electrically conductive layers through cuts 606 and 702 in at least one electrically insulating intermediate layer, using a data processor. The method 800 starts at 802, where existing or previously routed initial interconnections in the electrically conductive layers and previously placed initial cuts for vias connecting thereto through the intermediate layers have been registered. The method 800 comprises generating 804 blockage and/or obstruction statements which define exclusion regions of the conductive layers blocked for routing additional interconnections in the electrically conductive layers. Shape, size and spacing data for de-selection areas of the exclusion regions of the conductive layers are generated 812 to 820. The de-selection areas are sufficiently far from the boundaries of the exclusion regions that cut spacing rules applied to the initial cuts within the de-selection areas would not block placement of additional cuts outside the exclusion regions of the conductive layers. Those of the initial cuts which lie outside the de-selection areas are selected. Blockage and/or obstruction statements are generated 814 to 818 for the selected cuts outside the de-selection areas. A layout view is derived, including routing the additional interconnections in the electrically conductive layers and placing the additional cuts connecting thereto. The layout view is subsequently used, and may be stored for re-use as a standard cell, in producing masks and the masks are used in producing semiconductor integrated circuits.

It will be appreciated that any suitable method may be employed in producing the abstract view, in deriving the layout view, in producing the mask using the layout view, and in producing the semiconductor integrated circuit using the mask. The following description refers to a bottom-up LEF hierarchical process for generating LEF obstruction statements in an abstract view for use in routing and placing wires and vias in upper hierarchies in a hierarchical layout view. However, it will be appreciated that the method is also applicable in a top-down DEF hierarchical process for generating DEF blockage statements used in routing and placing wires and vias in lower hierarchies in a hierarchical layout view. The method is also applicable where other automatic or semi-automatic routing and placement tools are used. The following description refers to cuts, but it will be appreciated that the method is applicable to methods of providing the cuts for vias which are not necessarily produced by cutting physically the intermediate insulating layer.

In more detail, the method 800 includes performing algorithms wholly or partially in a data processor, such as a general purpose computer (not shown), for example, with possible manual input of the values of relevant parameters to generate obstructions for the IC 300. The obstruction generation algorithm of the method 800 starts at 802, by producing an abstract view of existing or previously routed initial interconnections in the electrically conductive layers and previously placed initial cuts for vias connecting thereto through the intermediate layers. The method 800 comprises including generating 804 corresponding blockage and/or obstruction statements. At 804, blockage and/or obstruction statements are generated which define exclusion regions of the conductive layers blocked for routing additional interconnections in each of the electrically conductive layers (‘metal wire’) layers M(i), with i=1 to N. The following statements are an example of an algorithm for extraction 806 of the exclusion regions of metal layer ‘i’ that are not available for placing additional metal or cuts due to spacing rules:

```
For i = #lowest_metal_index to #highest_metal_index
      S = (2*MINSPACING(M(i)) + MINWIDTH(M(i))) / 2
      T = (M(i) PIN) OR (M(i) OBS)
      R(M(i)) = (T SIZE S) SIZE −S
End For
```

where M(i) is the ith metal layer, S is the sizing criterion based on the spacing criterion for wire shapes in the metal layer M(i), T defines the areas blocked by pin ports and obstructions in the layer M(i), and R(M(i)) defines the exclusion regions of the metal layer M(i) which are unavailable for placing vias and routing other metal wires by the automatic routing tool for interconnecting components of the IC. The automatic routing tool will recognize the obstruction property of these exclusion regions and keeps the wires away.

A via and the corresponding cut cannot be placed without having metal wires both above and below it. At 808, exclusion regions R(V(i)) of each of the intermediate insulating ‘cut’ layers are extracted that are blocked for placing vias through that cut layer because metal wires connecting to the vias in either or both of the upper and lower routing layers M(i) and M(i+1) are blocked. The following statements are an example of an algorithm for extraction 808 of the exclusion regions R(V(i)) of cut layer ‘i’ that are blocked for placing cuts by lack of room to route a connection to the via either in metal layer ‘i’ or in metal layer ‘i+1’:

R(V(i))=R(M(i)) OR R(M(i+1)).

In this example, the obstruction statements for existing cuts are then simplified at 810 by first increasing the size of the individual existing cuts within the exclusion regions R(V(i)) by the cut spacing criterion S so that adjacent discontinuous individual cuts merge into continuous single simple shapes. The sizes of the merged regions G(V(i)) are then reduced by the value S to avoid exaggerating their size. The following statements are an example of an algorithm for extraction 808 of the merged areas G(V(i)) of cut layer ‘i’ that are occupied by existing adjacent vias, in the exclusion regions R(V(i)):

S=MAX(cut_array_gaps)/2

G(V(i))=((V(i)DRAWING)SIZE S)SIZE −S

The required spacing of a cut from an array of cuts depends on the number of cuts in the array as well. So, to ensure all potentially relevant existing cuts are included in the array, the size of individual cuts in the exclusion regions R(V(i)) is assumed to be increased by a maximum gap between cuts, as defined in the technology information of the layer.

In this example of an embodiment of the invention, obstructions or blockages are created only for those individual (or merged) cuts which might cause potential cut spacing design rule violations if omitted, since cut spacing rules may impose greater spacing than metal spacing rules. Accordingly, redundant data for many existing cuts which are situated too far inside the boundaries of the exclusion regions R(V(i)) to influence placing of additional cuts outside the exclusion regions are filtered out during steps 812 to 820 and their equivalent obstructions/blockages are not created. At 812, the criteria for this filtering are defined for each type of spacing rule and their required via sizes. It should be noted that the maximum sizing criteria is chosen for a via width size to provide desired accuracy without impacting performance of the algorithm. The following statements are an example of an algorithm for defining these criteria:

```
S′ = MAX(ADJACENTCUTS_Spacing_Rules(V(i)))
OM = MINSPACING(M(i+1)) + MINENCLOSURE(V(i),M(i+1))
OM′ = MINSPACING(M(i)) + MINENCLOSURE(V(j),M(i))
S = S′ − OM;
For all inter_layer_spacing of V(i) with V(j)
  If j==i+1 Then
    S″ = SPACING(V(i),V(j)) − OM
  Else If j==i−1 Then
    S″ = SPACING(V(i),V(j)) − OM′
  Else
    S″ = SPACING(V(i),V(j))
  End If
  If S″ > S Then
      S = S″
  End If
End For
W = MINWIDTH(V(i)) ; SWps = { (S,W) }
For all n in array_sizes
      W = n*MINWIDTH(V(i))+(n−1)*ARRAYCUTSPACING(V(i),n)
      S = ARRAYSPACING(V(i),n) − OM
      SWps = { (S,W) SWps }
End For
```

where S′ is the maximum of all ‘ADJACENTCUTS’ spacing rules for the cut layer V(i), OM and OM′ are the criterion for vias to adopt the minimum spacing and enclosure criteria for the upper metal layer i+1 and lower metal layer i respectively, W is the criterion for vias to adopt the minimum width, S is the sizing criterion for cut array spacing for a given via array size and is derived after subtracting the required metal offset OM from spacing rule for the given via array size, SW_{PS} is the resulting set of values for relevance of intra-layer and inter-layer spacing criteria to placing additional cuts in the same cut layer ‘i’, The sizing criteria in SW_{PS} specify the distance inside via exclusion region R(V(i)) of 808 from its boundary for which existing cuts may be relevant to placing additional cuts outside the exclusion region R(V(i)). Hence, at 814 shape, size and spacing data for a de-selection area are defined, as a function of the sizing criteria of 812, within which individual cuts lie sufficiently far from the boundaries of the via exclusion region R(V(i)) that they would not block placement of additional cuts outside said exclusion regions of said conductive layers and hence should not be considered for generating obstructions. Those of the initial cuts which lie outside the de-selection areas are selected at 816. Cut blockage and/or obstruction statements are generated for the selected cuts outside the de-selection areas at 818.

In more detail, at 816, the simplified merged cut array shapes outside the de-selection area defined in 814 are filtered by traversing from smallest to largest de-selection region to find all the relevant simplified merged cut array shapes of 810. The smallest de-selection region is initialized as R′ using the largest sizing criteria and grown incrementally to derive larger de-selection regions. This method of traversing de-selection regions maximizes performance by filtering out the shapes which have already been processed. The following statements are an example of an algorithm for performing these operations:

```
SWₚₛ = SORT_DESCENDING(SWₚₛ)
S′ = SPACE(SWₚₛ(0)) ; G′ = G(V(i)) ; G″ = EMPTY ; R′ = R(V(i))
SIZE −S′
For all {S,W} in SWₚₛ
      S″ = S′ − S ; R′ = R′ SIZE S″ ;
      {G′, TG′} = { (G′ OUTSIDE R′) < W, >= W }
      G″ = G″ OR TG′ ; S′ = S
End For
```

where S and S′ are loop iterators for storing the current and last used sizing value, S″ is the difference between the last and current sizing values, and R′ is the de-selection area within the via exclusion region R(V(i)). Inside the de-selection area R′ cut shapes are considered not relevant for obstruction generation. R′ is resized at each iteration as a function of S′ and S″. G′ stores the selected simplified merged cut arrays and individual shapes G(V(i)) outside the de-selection area R′ and which might be relevant for cut obstruction generation for the next sizing value, and G″ stores the final set of selected cut array areas (shapes) which will be used to generate actual cut obstructions. In every iteration of the first ‘For’-loop the selected simplified merged cut arrays and individual shapes G′ which lie outside the resized, de-selection area R′ and are greater than or equal to the width (size) relevant for avoiding design rule violations by additional cuts, are selected for the next iteration, and those which are smaller are filtered out. These selected simplified merged cut arrays and shapes G′ are then stored in G″. However many times additional simplified cut array shapes are selected for generating obstruction statements as G″, the filtering algorithm only needs to run once for existing cuts and subsequently for the added cuts, which limits the computational load.

At 818, obstruction statements are created only for each of the individual cuts or simplified merged cut arrays and individual cuts stored within the final G″ at 816. The following statements are an example of an algorithm for performing this operation:

OBS(V(i))=(V(i)DRAWING)INSIDE G″

where OBS(V(i)) is the obstruction for the via cut V(i) for the ith cut layer.

At 820, a decision is taken whether all the cut layers have been processed. If the decision at 820 is that all the cut layers have not yet been processed, the steps 812 to 818 are iterated for the next successive cut layer. When the decision at 820 is that all the cut layers have been processed, the obstruction generation process of FIG. 8 stops at 822.

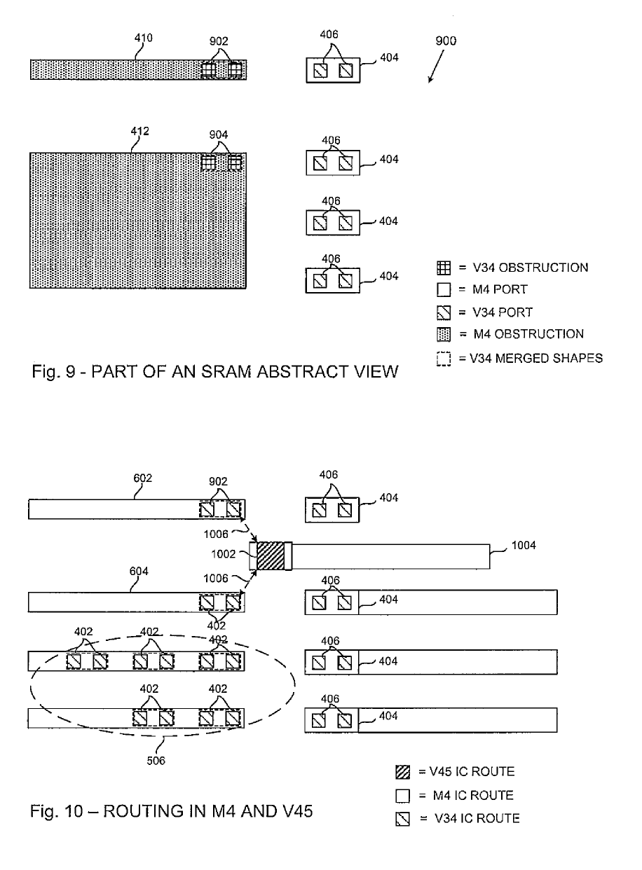

FIG. 9 is an Abstract view (LEF) 900 of the part of the IC 300 shown in the layout view of FIG. 3 illustrating cut obstructions as used in this example of an embodiment of the present invention. All the unnecessary cut obstructions highlighted in FIG. 5 are filtered out without requiring any optimistic or pessimistic obstructions like those shown in FIG. 6 and FIG. 7. The abstract view faithfully creates as obstructions for relevant individual cuts and cut arrays so as to ensure automatic routing tool can see the exact spacing rule it needs to apply. The merged cut array shapes are temporary, contributing a reduction in the amount of data to be handled, and are not used after the algorithm of the abstract view completes.

The Abstract view 900 contains detailed individual cut obstructions as generated by the process 800 for the relevant V34 cuts such as the arrays 902 and 904 only, excluding the cuts indicated at 506 in FIG. 5. The Abstract view 900 also contains M4 layer ports such as 404, V34 cut layer ports such as 406 and M4 metal layer obstructions 410 and 412, the obstruction 410 covering a single metal connector 304, and obstruction 412 covering a plurality of the metal connectors 304, by way of example.

FIG. 10 shows the M4 and V45 interconnect routes 1000 resulting from the automated routing tool using the Abstract view of FIG. 9 for the IC 300. The interconnect routes 1000 include a V45 layer cut 1002 and an M4 layer metal connection 1004, in addition to the elements shown in the Abstract view 900. The resulting M4 and V45 interconnect routes 1000 ensure that the V45 cut 1002 is sufficiently far away from all the V34 cuts 902, 904 (and also from the V34 cuts 402 indicated at 506) to avoid cut spacing design rule violations, as indicated by the arrows 1006. However, the Abstract view process takes account of data for the V34 cut obstructions 402 shown within the area of the dashed oval 506 only by verifying that they are too far from the boundary of the metal exclusion regions 410 and 412 to cause a risk of violating cut spacing design rules, since no V45 cut is close to them anyway, without generating blockages or obstructions for them.

The invention may be wholly or partially implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

For example, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

1. A method of layout and production of a semiconductor integrated circuit including vias connecting a plurality of stacked electrically conductive layers through cuts in at least one electrically insulating intermediate layer, the method comprising:
registering previously routed initial interconnections in said electrically conductive layers and previously placed initial cuts for vias connecting thereto through said intermediate layers;
generating interconnection blockage and obstruction statements that define exclusion regions of said conductive layers blocked for routing additional interconnections in said electrically conductive layers;
generating shape, size and spacing data for de-selection areas of said exclusion regions of said conductive layers, wherein said de-selection areas are sufficiently far from the boundaries of said exclusion regions that cut spacing rules applied to said initial cuts within said de-selection areas do not block placement of additional cuts outside said exclusion regions of said conductive layers;
selecting ones of said initial cuts that lie outside said de-selection areas;
generating cut blockage and obstruction statements for the selected cuts outside said de-selection areas;
deriving a layout view, including routing said additional interconnections in said electrically conductive layers and placing said additional cuts connecting thereto;
using said layout view to produce a mask; and
using said mask to produce said semiconductor integrated circuit.

2. The method of claim 1, wherein generating said shape, size and spacing data includes generating merged shape, size and spacing data for merged arrays of said initial cuts outside said de-selection areas.

3. The method of claim 1, wherein generating cut blockage and obstruction statements for the selected cuts outside said de-selection areas includes generating blockage and obstruction statements for said merged arrays of cuts and generating blockage and obstruction statements for other individual ones of said selected cuts.

4. The method of claim 1, wherein generating shape, size and spacing data for de-selection areas is a function of intra-layer cut spacing data and inter-layer cut spacing data.

5. The method of claim 1, wherein the ones of said initial cuts of arrays of said initial cuts that lie outside said de-selection areas are selected for generating cut blockage and obstruction statements only if their sizes are greater than a defined limit.

6. The method of claim 1, wherein said shape, size and spacing data for said de-selection areas are re-defined iteratively to include or exclude said initial cuts and arrays of said initial cuts as a function of their size.

7. A non-transitory computer readable medium with a computer program element thereon that is executable by a data processor in a layout method of a semiconductor integrated circuit including vias connecting a plurality of electrically conductive layers through cuts in at least one electrically insulating intermediate layer, the computer program element comprising instructions for:
registering previously routed initial interconnections in said electrically conductive layers and previously placed initial cuts for vias connecting thereto through said intermediate layers;
generating interconnection blockage and obstruction statements that define exclusion regions of said conductive layers blocked for routing additional interconnections in said electrically conductive layers;
generating shape, size and spacing data for de-selection areas of said exclusion regions of said conductive layers, wherein said de-selection areas are sufficiently far from the boundaries of said exclusion regions that cut spacing rules applied to said initial cuts within said de-selection areas do not block placement of additional cuts outside said exclusion regions of said conductive layers;
selecting ones of said initial cuts that lie outside said de-selection areas;
generating cut blockage and obstruction statements for the selected cuts outside said de-selection areas; and
deriving a layout view for use in producing a mask and said semiconductor integrated circuit, including routing said additional interconnections in said electrically conductive layers and placing said additional cuts connecting thereto.

8. The non-transitory computer readable medium of claim 7, wherein generating said shape, size and spacing data includes generating merged shape, size and spacing data for merged arrays of said initial cuts outside said de-selection areas.

9. The non-transitory computer readable medium of claim 7, wherein generating cut blockage and obstruction statements for the selected cuts outside said de-selection areas includes generating blockage and obstruction statements for said merged arrays of cuts and generating blockage and obstruction statements for other individual ones of said selected cuts.

10. The non-transitory computer readable medium of claim 8, wherein generating shape, size and spacing data for de-selection areas is a function of intra-layer cut spacing data and inter-layer cut spacing data.

11. The non-transitory computer readable medium of claim 8, wherein the ones of said initial cuts of arrays of said initial cuts that lie outside said de-selection areas are selected for generating cut blockage and obstruction statements only if their sizes are greater than a defined limit.

12. The non-transitory computer readable medium of claim 8, wherein said shape, size and spacing data for said de-selection areas are re-defined iteratively to include or exclude said initial cuts and arrays of said initial cuts as a function of their size.
